(19) United States
(12) Patent Application Publication
(10) Pub. No.: US 2007/0290000 A1
(43) Pub. Date: Dec. 20, 2007

(54) Process and installation for decanting a thermosetting resin

(76) Inventors: Alain Jacquemin-Verguet, Macornay (FR); Christophe Petit, Simard (FR); Jean-Charles Giboudot, Voiteur (FR); Denis Marlin, Domblans (FR)

Correspondence Address: Ralph A. Dowell of DOWELL & DOWELL P.C., 2111 Eisenhower Ave, Suite 406, Alexandria, VA, 22314, US

(21) Appl. No.: 11/727,649

(22) Filed: Mar. 27, 2007

(30) Foreign Application Priority Data
Mar. 27, 2006 (FR) 06 02639

(51) Int. Cl. B67D 5/62; B29B 13/02

(52) U.S. Cl. 222/146.5

(57) ABSTRACT

This process for removing a thermosetting resin 4 from its storage barrel 3 comprises a stage in which the resin is made to flow by gravity towards the outside of the barrel through an orifice 35 directed downwards, by heating the resin at least in the vicinity of an orifice to a heating temperature substantially lower than the crosslinking temperature of the resin and maintaining (in 53) the resin flowing at the heating temperature.

The present invention relates to a process for removing thermosetting resin from its storage barrel. The invention also relates to an installation for removing thermosetting resin from its storage barrel comprising a heating device for the resin.

The aeronautical and automotive industries use parts made of composite materials manufactured according to a process known as resin transfer moulding (RTM), consisting of injecting a thermosetting resin into a mould inside which a fibrous reinforcement has previously been positioned. The thermosetting resin used in this process is conventionally stored and transported in a storage barrel and has to be removed from this barrel for injection into the mould. However, it is common for a thermosetting resin to be at ambient temperature in the form of a high-viscosity paste. In these circumstances, the resin has to be heated to reduce its viscosity and thus allow it to be removed from the barrel and flow into the mould. This heating has to be carried out at a temperature that absolutely has to be lower than the crosslinking temperature of the resin in order to avoid polymerisation of the thermosetting system, which is a strongly exothermic reaction.

The extraction of a thermosetting resin from its storage barrel using a heating piston suitable for sliding in the barrel containing the resin is known. In this system, the piston heats the resin to a temperature lower than its crosslinking temperature, while applying pressure to the resin. Thus, a film of heated resin of substantially reduced viscosity forms in the vicinity of the piston surface and, under the effect of the pressure applied by the piston, passes through an orifice of the piston and flows towards the outside of the barrel. In this system, removal of the resin from the barrel is irregular, with relatively low output, since the resin has to be heated layer by layer to allow it to pass into the piston orifice. Moreover, there is a risk of wear and chemical attack of the seals between the piston and the side walls of the barrel. Such damage to the seals may cause resin leaks in the region of the edges of the piston. The resin is then likely to harden and immobilise the system, and cleaning the installation is time-consuming and difficult.

The invention is most particularly intended to overcome these drawbacks, by proposing a process and an installation for removing a thermosetting resin from its barrel allowing a continuous flow of resin out of the barrel, the risk of immobilisation of the installation due to resin leaks being limited.

Accordingly, the invention relates to a process for removing a thermosetting resin from its storage barrel, characterised in that the resin is made to flow by gravity out of the barrel through an orifice facing downwards, by heating the resin at least in the vicinity of the orifice to a heating temperature substantially lower than the crosslinking temperature of the resin and maintaining the flowing resin at the heating temperature.

According to other advantageous features of the invention:

the resin is heated by means of a heating device regulated to the heating temperature, arranged outside and beneath the barrel, the orifice being opposite a heated channel arranged in the heating device;

the resin is made to flow by gravity in the channel, the resin being distributed by gravity to the surface of at least one heating deflector and flowing through at least one slot of the deflector;

the orifice is provided with a punch connector suitable for conducting heat and comprising a stopper for the orifice;

the resin that flows to the lower end of the channel is collected in at least one container maintained at the heating temperature.

The invention also relates to an installation for removing thermosetting resin from its storage barrel comprising a resin heating device, this heating device being arranged outside and beneath the barrel and provided with a heated channel designed to receive the flow of resin by gravity from an orifice of the barrel, the channel comprising at least one heating deflector arranged transversely in the channel.

According to other advantageous characteristics of the installation:

the deflector has a face of substantially parabolic form oriented towards the orifice and comprises peripheral slots designed for the resin flow;

the orifice is pierced in a wall of the barrel suitable to be attached reversibly on the barrel;

the orifice is provided with a punch connector suitable for conducting heat and comprising a stopper for the orifice, the heating device comprising means for controlling stopper;

the installation comprises a manipulator for gripping the barrels suitable for causing the barrel to pivot to take the orifice downwards.

The features and advantages of the invention will appear in the description that follows of an embodiment of an installation and process according to the invention, given solely as an example and with reference to the accompanying drawings, in which:

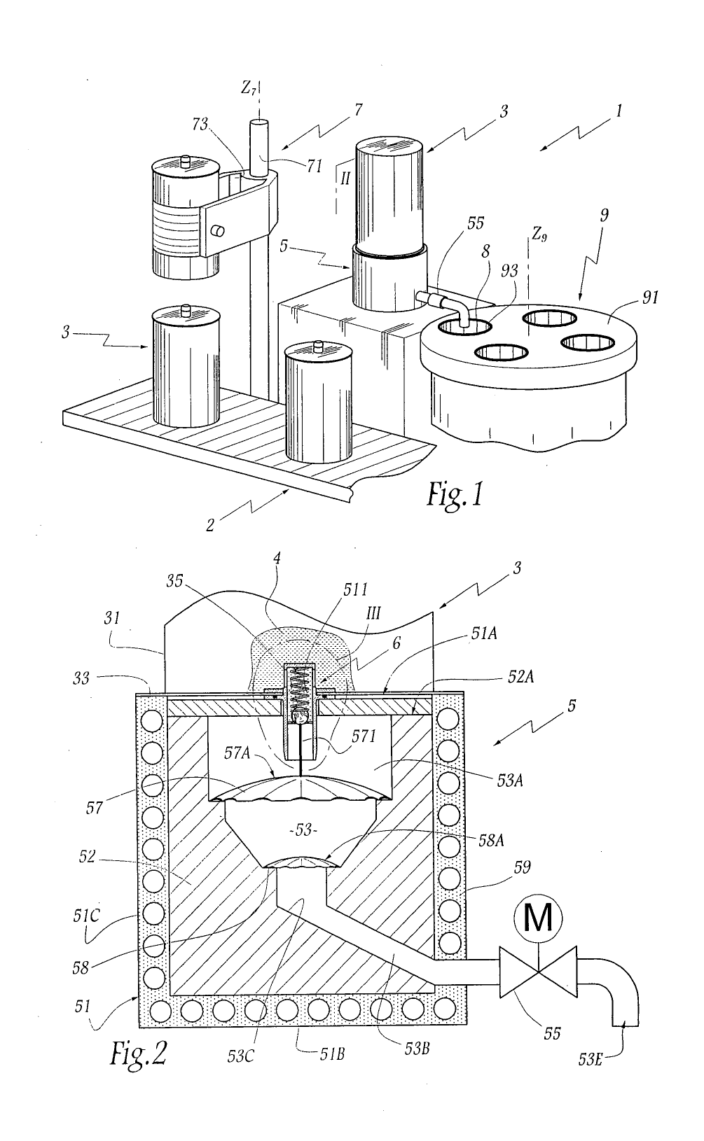

FIG. 1 is a diagrammatic perspective view of an installation according to the invention;

FIG. 2 is a cross-section on a larger scale along the plane II of FIG. 1;

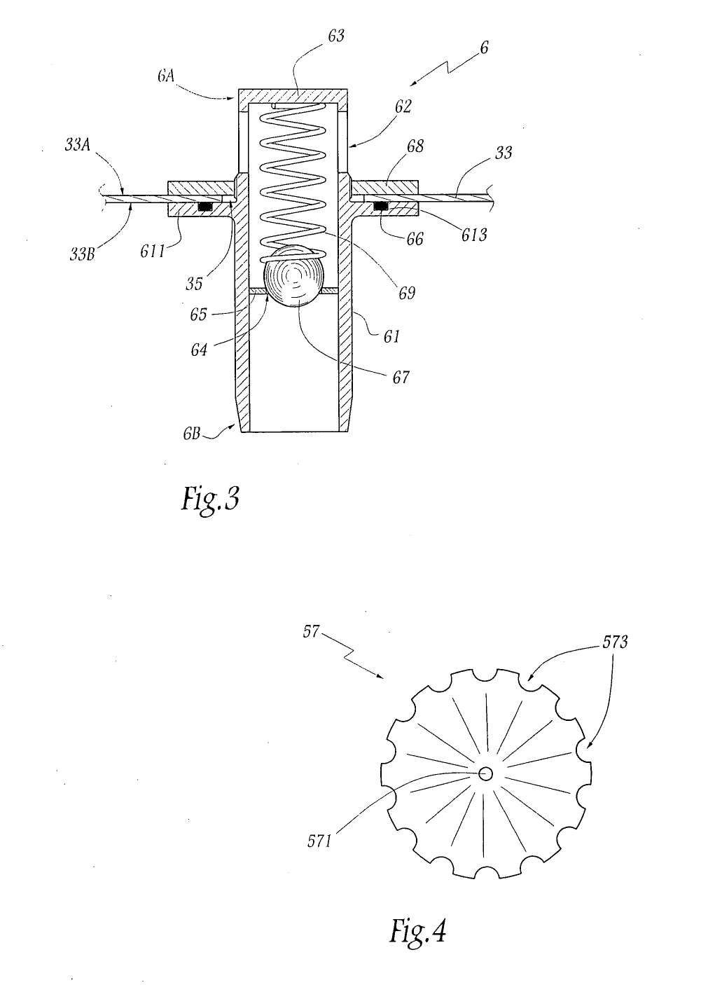

FIG. 3 is a view on a larger scale of the detail III of FIG. 2;

FIG. 4 is a view from above on a larger scale of a deflector used in the portion of the installation illustrated in FIG. 2.

The installation 1 illustrated in FIG. 1 is designed for the removal of a thermosetting resin 4 from its storage barrel 3.

As an example, the thermosetting resin 4 may be a single-component epoxy resin having at ambient temperature the form of a highly viscous paste, the viscosity of which decreases through heating, an advantageous heating temperature being approximately 80° C. At this heating temperature, which is substantially lower than the crosslinking temperature of the resin, the resin 4 is sufficiently fluid for it to be removed and flow by gravity out of the barrel 3.

The installation 1 comprises a conveyor 2 provided to take the barrels 3 containing the resin 4 to a manipulator 7 for gripping the barrels 3. Each barrel 3 arranged on the conveyor 2 has previously been prepared for removal of the resin 4. More precisely, each barrel 3 comprises an orifice 35 pierced in a wall 33 of the barrel 3. In the embodiment described, the orifice 35 is arranged in the cover 33 of the barrel 3 and the barrels 3 are arranged on the conveyor 2 with their cover 33 facing upwards. According to a variant of the invention that has not been illustrated, the orifice 35 may be arranged in a part that does not belong to the barrel 3 and is designed to be attached on the body 31 of the barrel 3 replacing the cover 33. According to another variant, the orifice 35 may be present initially on the barrel 3 from the supplier.

The orifice 35 of each barrel 3 is provided with a punch connector 6 of generally tubular form, which traverses the orifice 35 as can be seen in FIG. 3. A first end 6A of the punch connector 6 projects inside the barrel 3 when the cover 33 is in place on the barrel 3 and comprises a transverse end wall 63. A second end 6B of the punch connector 6 is open and leads towards the outside of the barrel 3 when the cover 33 is in place on the barrel 3. The side wall 61 of the punch connector 6 comprises, in the vicinity of the end 6A, four elongated openings 62 opening towards the inside of the barrel 3.

The punch connector 6 also comprises an external peripheral flange 611 suitable for resting, in the vicinity of the orifice 35, against the face 33B of the cover 33 designed to be oriented towards the outside of the barrel 3. The punch connector 6 is fixed on the cover 33 by means of a nut 68 which grips the punch connector 6 on the side of the face 33A of the cover 33 designed to be oriented towards the inside of the barrel 3. The nut 68 is suitable for holding the flange 611 resting against the face 33B of the cover 33. An O-ring joint 66 is provided in an annular groove 613 of the flange 611 to seal the punch connector 6 when it is fixed on the cover 33.

The punch connector 6 comprises an internal flange 65 delimiting an opening 64 inside the tubular punch connector 6. A ball 67, arranged inside the punch connector 6 between the flange 65 and the end 6A of the punch connector 6, forms a stopper for the opening 64. The ball 67 is maintained in its position closing the opening 64 by a compression spring 69 inserted between the end 6A of the punch connector 6 and the ball 67.

The walls 61 and 63 of the punch connector 6 are formed from a heat conducting, for example metallic, material, and are suitable for conducting heat between the outside and the inside of the barrel 3.

The function of the manipulator 7 for gripping the barrels 3 is to seize a barrel 3 provided with a punch connector 6 located at the downstream end of the conveyor 2, and move this barrel 3 to position it opposite a heating device 5, with its cover 33 facing downwards. Accordingly, the manipulator 7 comprises a body 71 with a substantially vertical longitudinal axis Z₇, on which is mounted a gripping arm 73 for the barrels 3. The arm 73 is suitable for sliding parallel to the axis Z₇ and pivoting around the axis Z₇. The arm 73 is also suitable for causing the barrel 3 that it carries to pivot around an axis perpendicular to the axis Z₇ so as to turn the barrel 3 over and direct its cover 33 downwards.

The heating device 5 of the installation 1 comprises a generally cylindrical body 51, of which the bottom 51B and the side wall 51C are bordered by a heating belt 59. A heating block 52 is arranged in the body 51 and delimits an internal channel 53 of the device 5. The heating block 52 is made of aluminium and is suitable for being heated and regulated by the heating belt 59 to a heating temperature of approximately 80° C.

The channel 53 comprises two main portions 53A and 53B. An upper portion 53A of the channel 53 extends substantially vertically from an upper wall 52A of the heating block 52 towards a central portion of the heating block, while a lower portion 53B of the channel 53 extends in an oblique direction from the central portion of the heating block towards the bottom 51B of the body 51. The lower portion 53B traverses a side wall 51C of the body 51 in the vicinity of the bottom 51B to lead to the outside of the device 5. Thus, the channel 53 is capable of allowing the resin 4 to flow by gravity successively in the portions 53A and 53B, the resin 4 being heated in the channel 53 and directed by gravity towards an end 53E of the channel 53 situated outside of the body 51.

The lower portion 53B of the channel 53 is provided with a motorised closing valve 55, arranged outside the body 51 in the vicinity of the end 53E of the channel 53. The valve 55 is suitable for selectively preventing the resin 4 from flowing out of the channel 53.

The upper portion 53A of the channel 53 comprises two heating deflectors 57 and 58 placed one above the other. These deflectors are made of aluminium and heated to the heating temperature of approximately 80° C. by contact with the heating block 52. Each deflector 57 or 58 is arranged transversely in the channel 53 and designed to increase the heating surface of the resin 4 in the channel 53.

The deflectors 57 and 58 have identical profiles, a view from above of the upper deflector 57 being shown in FIG. 4. Each deflector 57 or 58 has a generally circular cross-section, the diameter of the lower deflector 58 being lower than the diameter of the upper deflector 57. The upper walls 57A and 58A of the deflectors 57 and 58 are of generally parabolic and convex form, so as to increase the specific contact surface between the resin 4 and the heating deflectors.

As can be seen in FIG. 4, each deflector 57 or 58 comprises peripheral slots, bearing the reference numeral 573 in FIG. 4, designed for the flow by gravity of the resin 4 from the upper wall 57A or 58A of the deflector towards the portion of the channel 53 situated beneath the deflector. The presence of these slots at the periphery of the deflectors 57 and 58 allows the flow of resin 4 to be guided along the side walls 53C of the channel 53, in other words in contact with the heating block 52, which improves heating of the resin 4. The portion 53A of the channel 53 has a generally tapered cross-section between the deflectors 57 and 58, which allows the flow by gravity of the resin 4 to be forced between the two deflectors.

The deflector 57 comprises a control pin 571, which extends from its wall 57A in the direction of the upper wall 52A of the heating block 52. The pin 571 is aligned with a housing 511 arranged in the body 51 and designed for the passage of the punch connector 6. When the punch connector 6 is introduced in the housing 511, the pin 571 is suitable for releasing the opening 64 of the punch connector by moving the ball 67 against the spring 69.

The installation 1 according to the invention also comprises a carousel 9 for recovering the resin 4 flowing in the region of the end 53E of the channel 53. The carousel 9 comprises a heating block 91 regulated to the heating temperature of approximately 80° C. and provided with housings 93 designed to hold pots or “pails” 8 to receive the resin 4. The carousel 9 is suitable for pivoting around a substantially vertical axis Z₉ so as to take the pots 8 successively beneath the end 53E of the channel 53. The pots 8 are made of a heat-conducting material so as to maintain the resin 4, which flows out of the channel 53 at the heating temperature, by contact with the block 91.

The installation 1 comprises a device which has not been illustrated for detecting the fill level of the pots 8, associated with a warning alarm in case the operating values of the detection device are exceeded. The installation 1 also comprises an emergency stop device, also not illustrated.

A process for removing the resin 4 from its storage barrel 3 comprises stages in which: Initially, an orifice 35 is pierced in the cover 33 of the barrel 3 and the orifice 35 is provided with a punch connector 6 as previously described. In a variant, the punch connector may be provided on a part that does not belong to the barrel 3 and is suitable for being added to the body 31 of the barrel 3 to replace its cover. In this case, a first stage of the process consists of removing the cover of the barrel 3 and fixing the part provided with the punch connector 6 on the body 31, in place of the cover. According to another variant, where the barrel 3 is already provided with an orifice, a first stage of the process consists of providing this orifice with the punch connector 6 taking care to ensure that the punch connector 6 is fixed and sealed in the pre-existing orifice.

The barrel 3 thus prepared is placed on the conveyor 2 supplying the barrels 3, the cover 33 facing upwards. When the conveyor 2 has positioned the barrel plumb with the arm 73 of the manipulator 7, said manipulator seizes the barrel 3 and moves it upwards, parallel to the longitudinal axis Z₇ of the body 71. The arm 73 then pivots around the axis Z₇ to take the barrel 3 above the heating device 5. The barrel 3 is then turned over so as to direct the cover 33 and the punch connector 6 downwards.

The arm 73 of the manipulator 7 moves the barrel 3 downwards parallel to the axis Z₇, until the punch connector 6 is introduced in the housing 511 of the device 5. The introduction of the punch connector 6 in the housing 511 centres the barrel 3 in relation to the upper wall 51A of the body 51.

When the punch connector 6 is introduced in the housing 511, the pin 571 of the deflector 57 moves the ball 67 of the punch connector 6 against the resilient force applied by the spring 69 and thus frees the opening 64. The resin 4 is then suitable for flowing by gravity through the elongated openings 62 and the opening 64 of the punch connector 6, towards the channel 53 of the device 5.

The resin 4 situated inside the barrel 3 is heated by means of the side 61 and transverse 63 walls of the punch connector 6, which conduct heat from the channel 53 towards the inside of the barrel 3. The viscosity of the resin 4 in the vicinity of the punch connector 6 therefore tends to reduce, which facilitates the flow by gravity of the resin 4 through the punch connector 6.

The resin 4 continues to be heated while it flows by gravity in the heated channel 53. The resin 4 is distributed by gravity on the generally parabolic upper walls 57A and 58A of the heating deflectors 57 and 58 and flows along the peripheral slots of these deflectors. Since the valve 55 is open, the heated resin 4 is recovered in a reception pot 8 situated plumb with the end 53E of the channel 53.

When the fill limit of the pot 8 is reached and detected by the detection device, the carousel 9 pivots around the axis Z₉ so as to take a new empty pot 8 plumb with the end 53E of the channel 53. The valve 55 is closed momentarily while the carousel 9 pivots.

This resin removal process thus allows a continuous flow of resin 4 from its storage barrel 3, the resin flowing by gravity and being heated continuously in the channel 53. The flow output of the resin 4 may reach relatively large values depending on the cross-section of the punch connector 6 and the specific contact surface of the heating area. This specific surface may be improved in particular by increasing the dimensions of the deflectors 57 and 58. Thus, by adapting the cross-section of the punch connector 6, the dimensions of the deflectors 57 and 58 and the heating power of the device 5, it is possible to guarantee a given output and temperature of the flow of resin 4. This output and temperature may be chosen according to the volume of resin consumed and its temperature of use.

Another advantage of the process and the resin removal installation is to allow the resin 4 to be extracted from its storage barrel 3 whatever the shape and diameter of the barrel. Furthermore, the risk of leakage of the resin 4 and of blocking the mechanisms is limited. If there is an overflow, the constituent parts of the installation 1 can be easily removed and cleaned, so as to reduce the immobilisation time of the installation.

1. Process for removing a thermosetting resin from its storage barrel, wherein the resin is made to flow by gravity out of the barrel through an orifice facing downwards, by heating the resin at least in the vicinity of the orifice to a heating temperature substantially lower than the crosslinking temperature of the resin and maintaining the flowing resin at the heating temperature.

2. Process according to claim 1, wherein the resin is heated by means of a heating device regulated to the heating temperature, arranged outside and beneath the barrel, the orifice being opposite a heated channel arranged in the heating device.

3. Process according to claim 2, wherein the resin is made to flow by gravity in the channel, the resin being distributed by gravity to the surface of at least one heating deflector and flowing through at least one slot of the deflector.

4. Process according to claim 1, wherein the orifice is provided with a punch connector suitable for conducting heat and comprising a stopper for the orifice.

5. Process according to claim 1, wherein the resin that flows to the lower end of the channel is collected in at least one container maintained at the heating temperature.

6. Installation for removing a thermosetting resin from its storage barrel, comprising a device for heating the resin, wherein the heating device is arranged outside and beneath the barrel and is provided with a heated channel designed to receive the flow by gravity of resin from an orifice of the barrel, the channel comprising at least one heating deflector arranged transversely in the channel.

7. Installation according to claim 6, wherein the deflector has a face of substantially parabolic form oriented towards the orifice and comprises peripheral slots designed for the flow of resin.

8. Installation according to claim 6, wherein that the orifice is pierced in a wall of the barrel suitable to be attached reversibly on the barrel.

9. Installation according to claim 6, wherein that the orifice is provided with a punch connector suitable for conducting heat and comprising a stopper for the orifice, the heating device comprising means for controlling the stopper.

10. Installation according to any one of claim 6, wherein that it comprises a manipulator for gripping the barrel suitable for causing the barrel to pivot to take the orifice downwards.
